(19) United States
(12) Patent Application Publication
(10) Pub. No.: US 2009/0186269 A1
(43) Pub. Date: Jul. 23, 2009

(54) RECHARGEABLE BATTERY

(75) Inventors: Yong-Sam Kim, Suwon-si (KR); Masanori Kogure, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd, Suwon-si (KR)

(21) Appl. No.: 12/273,690

(22) Filed: Nov. 19, 2008

(30) Foreign Application Priority Data
Jan. 23, 2008 (KR) 10-2008-0007155

(51) Int. Cl. H01M 2/02

(52) U.S. Cl. 429/179

(57) ABSTRACT

The present invention relates to a rechargeable battery. The rechargeable battery includes an electrode assembly, a case, electrode terminals, and a cap plate. The electrode assembly includes a separator and an anode and a cathode disposed at both sides of the separator. The case houses the electrode assembly. The electrode terminals are electrically connected to the electrode assembly and protrude outwardly from the case. The cap plate closes and seals the case. The cap plate includes a terminal hole for receiving the electrode terminals and a sealing reinforcing member formed along a circumference of the terminal hole and having a greater thicker than a periphery thereof.

### CROSS-REFERENCE TO RELATED APPLICATION

This application claims priority to and the benefit of Korean Patent Application No. 10-2008-0007155 filed in the Korean Intellectual Property Office on Jan. 23, 2008, the entire content of which is incorporated herein by reference.

### BACKGROUND OF THE INVENTION

1. Field of the Invention

The present invention relates to a rechargeable battery. More particularly, the present invention relates to a rechargeable battery including a cap plate with an improved structure.

2. Description of the Related Art

A rechargeable battery can be repeatedly charged and discharged, unlike a primary battery that is incapable of being recharged. A low capacity rechargeable battery has been used for small electronic devices such as a mobile phone, a laptop computer, and a camcorder, and a large capacity battery has been widely used as a power source for driving a motor of a hybrid vehicle.

Recently, a high power rechargeable battery assembly using a high energy density non-aqueous electrolyte has been developed. The high power rechargeable battery assembly is formed with a plurality of rechargeable batteries connected in series that may be cylindrical or rectangular in shape. The high power rechargeable battery assembly is used for driving a motor for an electric vehicle.

A rectangular rechargeable battery typically includes an electrode assembly having an anode and a cathode with a separator interposed therebetween, a case for housing the electrode assembly and, a cap plate for closing and sealing the case. The cap plate often has terminal holes for receiving positive and negative-electrode terminals that are electrically connected to the electrode assembly holes, and protrude outwardly from the case.

Internal pressure of a rechargeable battery increases due to a gas that is internally generated by repeatedly charging and discharging the rechargeable battery. Such a phenomenon is referred to as swelling. When the swelling occurs, a rechargeable battery may explode due to the increased internal pressure.

Therefore, the cap plate includes a vent plate made of a thin plate to discharge a gas generated in the rechargeable battery. The vent plate is disposed at a penetration hole formed at the center of the cap plate. Also, grooves are formed on the vent plate by pressurizing the vent plate with a press. The grooves allow the vent plate to be easily opened at a predetermined pressure.

In order to position a vent plate at the cap plate, a penetration hole is initially formed at the cap plate, and the vent plate is then fixed at the penetration hole by welding. It is difficult to directly form a bend at the cap plate because the thickness of the cap plate increases. Therefore, an additional vent plate is disposed at the cap plate through complicated processes as described above.

If the thickness of the cap plate is reduced to directly form a vent on the cap plate, the sealing of the case cannot be made as well at the terminal hole because a contact area of the terminal hole and a gasket may be too small. If the terminal hole is not completely sealed, electrolyte solution stored in the case may flow out, thereby shorting rechargeable batteries.

The above information disclosed in this Background section is only for enhancement of understanding of the background of the invention and therefore it may contain information that does not form the prior art that is already known in this Country to a person of ordinary skill in the art.

### SUMMARY OF THE INVENTION

The present invention has been made in an effort to provide a rechargeable battery having advantages of stably closing and sealing a terminal hole by improving the structure of a cap plate.

An exemplary embodiment of the present invention provides a rechargeable battery including a sealing reinforcing member on a circumference of a terminal hole of a cap plate for closing and sealing a case.

An exemplary embodiment of the present invention provides a rechargeable battery including an electrode assembly, a case, electrode terminals, and a cap plate having a peripheral region. The electrode assembly includes a separator, and an anode and a cathode disposed at both sides of the separator. The case houses the electrode assembly. The electrode terminals are electrically connected to the electrode assembly and protrude outwardly from the case. The cap plate closes and seals the case. The cap plate includes a terminal hole for receiving one of the electrode terminals and a sealing reinforcing member formed along a circumference of the terminal hole and that is thicker than a periphery thereof.

The cap plate may include a groove formed on a circumference of the sealing reinforcing member. Also, a protrusion may be formed on a circumference of the sealing reinforcing member in a form of a rib and protrude toward the case. An elastic deformation protrusion may be continuously formed on an interior circumference of the terminal hole along the interior circumference of the terminal hole, and the elastic deformation protrusion may be thinner than the peripheral region of the cap plate.

A gasket may be disposed at the terminal hole for insulating the electrode terminals from the cap plate, and a fixing groove may be formed on a bottom side of the cap plate for receiving a protrusion formed at the gasket.

The sealing reinforcing member may protrude toward a bottom side of the cap plate, and the sealing reinforcing member may protrude toward a top side of the cap plate.

A plurality of protrusions may be formed on an interior circumference of the terminal hole along the interference circumference of the terminal hole. The rechargeable battery may be a rectangular rechargeable battery.

A bent supporting member may be formed at an edge of the cap plate, and the bent supporting member and a top portion of the case may be in contact and may be fixed through welding. The gasket may include a lower gasket inserted into the terminal hole and an upper gasket disposed at a top side of the cap plate.

Another exemplary embodiment of the present invention provides a rechargeable battery including an electrode assembly, a case, electrode terminals, and a cap plate. The electrode assembly includes a separator, and an anode and a cathode disposed at both sides of the separator. The case houses the electrode assembly. The electrode terminals are electrically connected to the electrode assembly and protrude outwardly from the case. The cap plate closes and seals the case, and includes a terminal hole for receiving the electrode terminals. An elastic deformation protrusion is formed on an interior circumference of the terminal hole.

A sealing reinforcing member may be formed on a circumference of the terminal hole and may be thicker than the cap plate. The elastic deformation protrusion may be formed on an interior circumference of the sealing reinforcing member, and may be thinner than a periphery thereof.

According to an exemplary embodiment of the present invention, a sealing reinforcing member is formed on a circumference of a terminal hole to enlarge a contact area of a gasket and a terminal hole. Therefore, sealing performance between the electrode terminals and the cap plate is improved.

According to an exemplary embodiment of the present invention, a protrusion is formed on a circumference of a sealing reinforcing member. The protrusion protrudes downwardly and pressurizes a gasket. Therefore, sealing performance between a cap plate and a gasket is further improved.

According to an exemplary embodiment of the present invention, an elastic deformation protrusion is formed on an interior circumference of a terminal hole to have a thickness that is thinner than a periphery thereof. Therefore, sealing performance of the terminal hole is further improved.

According to an exemplary embodiment of the present invention, a fixing groove is formed on a bottom side of a cap plate to receive a protrusion formed at a gasket, and the fixing groove prevents the gasket from rotating.

### BRIEF DESCRIPTION OF THE DRAWINGS

FIG. 1 is a cross-sectional view illustrating a rechargeable battery according to the first exemplary embodiment of the present invention.

FIG. 2 is a cross-sectional view of a rechargeable battery according to the second exemplary embodiment of the present invention.

FIG. 3 is a perspective view of a cap plate according to the second exemplary embodiment of the present invention.

FIG. 4 is a cross-sectional view of one part of the cap plate of FIG. 3 taken along the line VI to VI.

FIG. 5 is a cross-sectional view of the cap plate of FIG. 3 taken along the line V-V.

FIG. 6 is a cross-sectional view of a cap plate in a rechargeable battery according to the third exemplary embodiment of the present invention.

FIG. 7 is a cross-sectional view of a cap plate in a rechargeable battery according to the fourth exemplary embodiment of the present invention.

FIG. 8 is a cross-sectional view of a cap plate in a rechargeable battery according to the fifth exemplary embodiment of the present invention.

### DETAILED DESCRIPTION OF THE EMBODIMENTS

Hereinafter, exemplary embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention. Like reference numerals designate like elements throughout the specification.

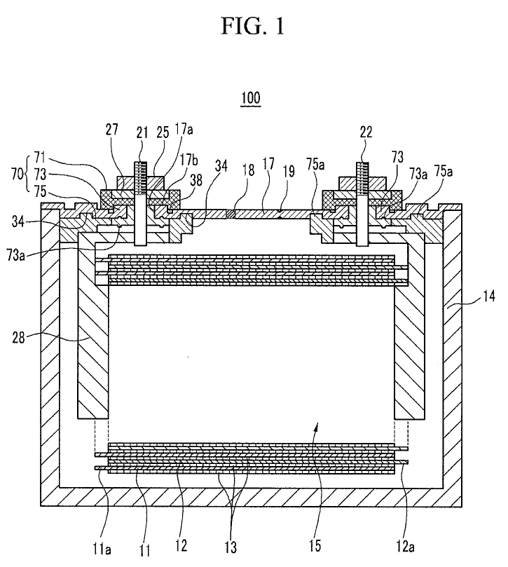

FIG. 1 is a cross-sectional view illustrating a rechargeable battery according to the first exemplary embodiment of the present invention.

Referring to FIG. 1, a rechargeable battery 100 includes an electrode assembly 15 having an anode 11 and a cathode 12 wound with a separator 13 interposed therebetween as an insulator. The battery 100 also includes a case 14 for housing the electrode assembly 15, and electrode terminals 21 and 22 which includes a positive terminal 21 and a negative terminal 22 that are electrically connected to the electrode assembly 15. The rechargeable battery 100 also includes a cap plate 17 for closing and sealing the case 14 and the cap plate 17 includes terminal holes 17a for receiving the electrode terminals 21 and 22.

The anode 11 and the cathode 12 include a coating region where a current collator formed of a thin metal foil is coated with an active material, and uncoated regions 11a and 12a where an active material is not coated. The uncoated regions 11a and 12a are formed at sides of the anode 11 and the cathode 12, respectively, along a length direction thereof. The anode 11 and the cathode 12 are spirally wound with the separator 13 interposed therebetween as an insulator, thereby forming the electrode assembly 15 in a generally jelly-roll form.

Although the present exemplary embodiment describes a rectangular rechargeable battery having the electrode assembly 15 formed in a jelly-roll shape the present invention is not limited thereto. The present invention may be applied to various shapes of rechargeable batteries such as a cylindrical rechargeable battery and the like.

The uncoated regions 11a and 12a of the electrode assembly are respectively electrically connected to the electrode terminals 21 and 22 through lead members 28. A screw is formed on an exterior circumference of each of the electrode terminals 21 and 22, and a nut 25 is coupled with a washer 27 as a medium, thereby supporting the electrode terminals 21 and 22 at an upper portion thereof.

The cap plate 17 is formed as a thin plate. The cap plate 17 includes terminal holes 17a for receiving the electrode terminals 21 and 22, an electrolyte injection opening 18 for injecting an electrolyte solution, and a vent member 19 formed as a groove to be broken at a predetermined internal pressure. A sealing reinforcing member 17b is formed about the circumference of the terminal hole 17a so as to be thicker than at a peripheral region of the cap plate 17, e.g., the flat interior portion thereof. An upper groove 38 is formed on a circumference of a sealing reinforcing member 17b. The upper groove 38 is continuously connected along the circumference of the sealing reinforcing member 17b.

The electrode terminals 21 and 22 protrude outwardly from the case 14 through the terminal holes 17a formed in the cap plate 17. A gasket 70 is interposed between the cap plate 17 and each of the electrode terminals 21 and 22, thereby insulating the cap plate 17 from the electrode terminals 21 and 22.

The gasket 70 includes a middle gasket 73 inserted in the terminal holes 17a, an upper gasket 71 disposed on the cap plate 17, and a lower gasket 75 disposed outside of the middle gasket 73 so as to surround the terminals. The upper gasket 71 is larger than the sealing reinforcing member 17b, and is disposed to surround the outer side of the sealing reinforcing member 17b in order to prevent the electrode terminals 21 and 22 from rotating.

The washer 27 is disposed at a top side of the upper gasket 71, and the nut 25 is screwed on the washer 27. Accordingly, the upper gasket 71 stably insulates the washer 27 and the nut 25 from the cap plate 17 by preventing the washer 27 and the nut 25 from being connected to the cap plate 17. A protrusion 75a is formed on the top side of the lower gasket 75, and a groove 34 is formed at the bottom side of the cap plate 17 for receiving the protrusion 75a. Therefore, the protrusion 75a is joined to the groove 34 so as to prevent the lower gasket 75 from moving on the cap plate 17.

Also, protrusions 73a are formed on a top side and a bottom side of the middle gasket 73 in a form of a rib. The protrusions 73a form a blocking layer to prevent the electrolyte solution from leaking from a gap between the gasket 70 and the cap plate 17.

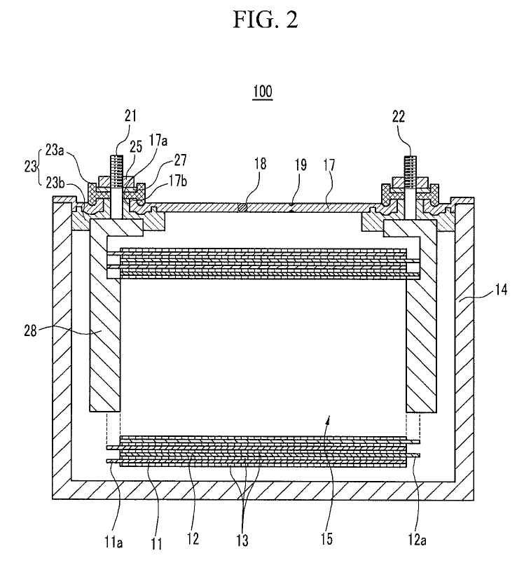

FIG. 2 is a cross-sectional view of a rechargeable battery according to the second exemplary embodiment of the present invention.

Referring to the drawing, a cap plate 17 is formed as a thin plate. The cap plate 17 includes terminal holes 17a for receiving electrode terminals 21 and 22, an electrolyte injection opening 18 for injecting an electrolyte solution, and a vent member 19 formed of grooves to be broken at a predetermined internal pressure. A sealing reinforcing member 17b is formed about a circumference of the terminal hole 17a, and the sealing reinforcing member is comparatively thicker than the periphery thereof.

The electrode terminals 21 and 22 protrude outwardly from the case 17 through the terminal holes 17a formed at the cap plate 17. A gasket 23 is interposed between the cap plate 17 and each of the electrode terminals 21 and 22, thereby insulating the cap plate 17 from the electrode terminals 21 and 22.

The gasket 23 includes a lower gasket 23b inserted into the terminal hole 17a and an upper gasket 23a disposed above the cap plate 17. The upper gasket 23a has a larger structure than that of the sealing reinforcing member 17b, and is disposed to surround the outer side of the sealing reinforcing member 17b in order to prevent the electrode terminals 21 and 22 from rotating.

A washer 27 is disposed on a top side of the upper gasket 23a, and a nut 25 is screwed on the washer 27. Therefore, the upper gasket 23a prevents the washer 27 and the nut 25 from being connected to the cap plate 17, thereby stably insulating the washer 27 and the nut 25 from the cap plate 17.

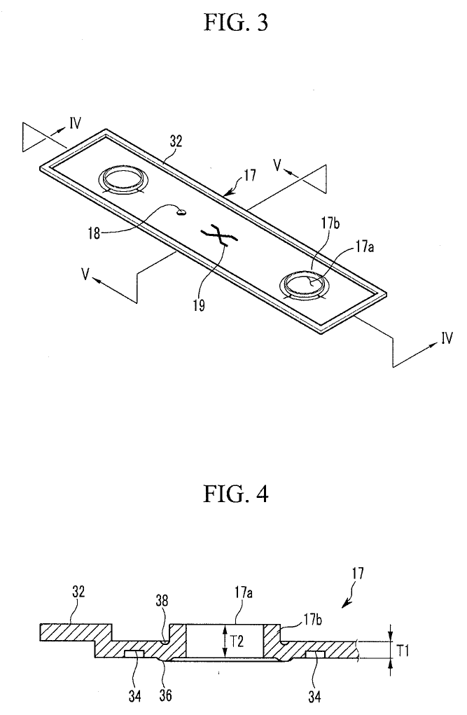

FIG. 3 is a perspective view of a cap plate according to the second exemplary embodiment of the present invention.

Referring to the drawing, the cap plate 17 according to the present exemplary embodiment is made of a thin plate. The cap plate 17 includes terminal holes 17a for receiving electrode terminals 21 and 22, an electrolyte injection opening 18 for injecting an electrolyte solution that operates as medium for ion conduction, and a vent member 19 for discharging gas generated in the rechargeable battery.

A bent supporting member 32 is formed on an exterior edge of the cap plate 17. A top side of the bent supporting member 32 is bent upwardly and extends outwardly, thereby forming a step. There, the outwardly expanding part thereof is positioned on the upper end of the case 14 in the manners shown in FIGS. 1 and 2. The bent supporting member 32 is fixed at the case 14 through welding, thereby closing and sealing the case and the cap plate 17. Also, a bent part of the bent supporting member 32 has a higher height than other parts. Therefore, the bent part helps to prevent the interior portion cap plate 17 from being bent or tilted.

FIG. 4 is a cross-sectional view of one part of the cap plate of FIG. 3 taken along the line VI to VI.

As shown in FIG. 4, the sealing reinforcing member 17b having a thickness T2 that is thicker than a thickness T1 the flat interior portion or a peripheral region of the plate 17. The sealing reinforcing member 17b is formed on a circumference of the terminal hole 17a. The sealing reinforcing member 17b stably closes and seals the case by expanding a contact area between the interior circumference of the sealing reinforcing member 17b and the gasket 70 in FIGS. 1 or 23 in FIG. 2. Accordingly, the height T2 of the terminal hole 17a is greater than the thickness T1 of the flat interior portion of the plate 17.

Although the sealing reinforcing member 17b of the present exemplary embodiment protrudes upwardly, the present invention is not limited thereto.

An upper groove 38 is formed on the circumference of the sealing reinforcing member 17b, and the upper groove 38 is continuous along the circumference of the sealing reinforcing member 17b. The upper groove 38 and a bottom side of the upper gasket 23a are in contact, thereby fixing the upper gasket 23a.

A lower protrusion 36 is formed downwardly at a bottom side where the upper groove 38 is formed. The lower protrusion 36 is also continuous along a circumference of the sealing reinforcing member 17b. The lower protrusion 36 and the lower gasket 23b are in contact. Since the lower protrusion 36 forms a blocking layer by pressurizing the lower gasket 23b, the sealing performance is further improved.

As described above, the upper groove 38 and the lower protrusion 36 are formed on the circumference of the sealing reinforcing member 17b corresponding to the top side and the bottom side of the cap plate. Therefore, the cap plate 17 has a bent structure.

The fixing groove 34 is formed at a bottom side of the cap plate 17 at a predetermined distance from the lower protrusion 36. As shown in FIG. 1, the fixing groove 34 prevents the lower gasket 23b from rotating by inserting a protrusion formed at the lower gasket 23b into the fixing groove 34.

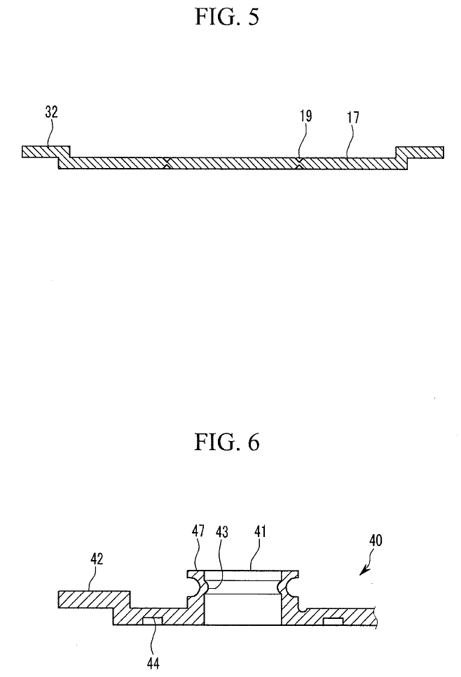

As shown in FIG. 5, the vent member 19 is integrally formed at the cap plate 17 in a form of a groove that is concave at one side or both sides of the cap plate 17. Also, the vent member 19 is formed as a continuous groove in order to be broken at a predetermined pressure.

FIG. 6 is a cross-sectional view of a cap plate in a rechargeable battery according to the third exemplary embodiment of the present invention.

Since the rechargeable battery according to the present exemplary embodiment has the same structure as the rechargeable battery according to the first exemplary embodiment except for the structure of a cap plate 40, detailed descriptions of the same elements are omitted.

Referring to FIG. 6, the cap plate 40 according to the present exemplary embodiment includes a terminal hole 41 and a sealing reinforcing member 47 formed about a circumference of the terminal hole 41. The sealing reinforcing member 41 is thicker than a periphery of the cap plate 40.

Like the rechargeable battery according to the first exemplary embodiment, a bent supporting member 42 is formed at an edge of the cap plate 40 and a fixing groove 44 is formed at a bottom side of the cap plate.

An elastic deformation protrusion 43 is formed at an interior circumference of the sealing reinforcing member 47. The elastic deformation protrusion 43 is continuously formed along the inner circumference of the sealing reinforcing member 47 in a form of a ring.

The elastic deformation protrusion 43 protrudes inward from the interior circumference of the sealing reinforcing member 47. The elastic deformation protrusion 43 has a lesser thickness than the thickness of the periphery of the cap plate 40 a periphery because a groove 45 is formed at an outer surface of the sealing reinforcing member 47 opposite the protrusion 43. The elastic deformation protrusion 43 may be formed to have half the thickness of the periphery of the cap plate 40.

Even though the electrode terminals 21 and 22 fit tightly into the terminal holes 41 when one of the electrode terminals 21 and 22 is inserted thereinto with the gasket 23 as a medium, the elastic deformation protrusion 43 allows the electrode terminals 21 and 22 to be easily inserted into the terminal holes 41 because the elastic deformation protrusion 43 can be elastically deformed. Also, the sealing performance may be improved by pressurizing the gasket 23 after inserting the electrode terminals 21 and 22 into the terminal holes 41.

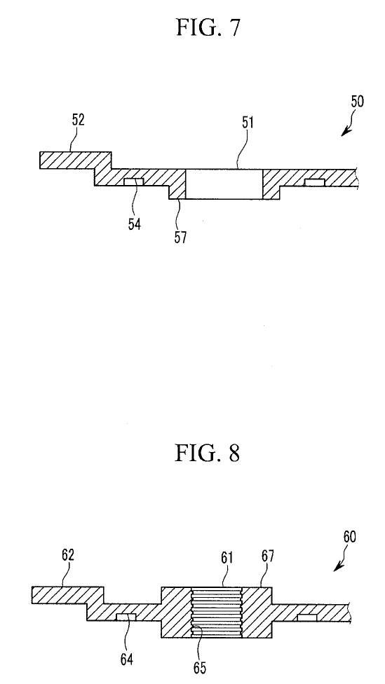

FIG. 7 is a cross-sectional view of a cap plate in a rechargeable battery according to the fourth exemplary embodiment of the present invention.

Referring to FIG. 7, the cap plate 50 according to the present exemplary embodiment includes a terminal hole 51 and a bent supporting member 52 formed at an edge thereof, and a fixing groove 54 is formed at a bottom side thereof. A sealing reinforcing member 57 is formed at a circumference of the terminal hole 51 to have a greater thicker than at the periphery of the cap plate 50. The sealing reinforcing member 57 protrudes downwardly to be thicker than at the periphery of the cap plate 50.

FIG. 8 is a cross-sectional view of a cap plate in a rechargeable battery according to the fifth exemplary embodiment of the present invention.

Referring to FIG. 8, the cap plate 60 according to the present exemplary embodiment includes a terminal hole 61 for receiving one of electrode terminals 21 and 22, a bent supporting member 62, and a fixing groove 64. A sealing reinforcing member 67 is formed on a circumference of the terminal hole 61 at a greater thicker than at the periphery, and the sealing reinforcing member 67 protrudes upwardly and downwardly from the cap plate 60. Accordingly, the contact area of the terminal hole 61 and the gasket 23 is further expanded by increasing the thickness of the sealing reinforcing member 67.

A block protrusion 65 is formed on an interior circumference of the terminal hole 61 toward the inside thereof. The block protrusion 65 is continuously connected along the interior circumference of the terminal hole 61. A plurality of block protrusions 65 are formed at a predetermined distance in a depth direction of the terminal hole 61.

Each block protrusion 65 forms a block layer by pressurizing the gasket 23 toward the inside. Since a plurality of blocking layers may be formed by the block protrusions 65, the sealing performance is further improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly including a separator, and an anode and a cathode disposed at respective sides of the separator;
a case for housing the electrode assembly;
electrode terminals electrically connected to the electrode assembly and protruding outwardly from the case; and
a cap plate for closing and sealing the case wherein the cap plate defines a peripheral region and has terminal holes for receiving the electrode terminals and a sealing reinforcing member formed along a circumference of each of the terminal holes wherein the sealing reinforcing member has a greater thickness than the peripheral region of the cap plate.

2. The rechargeable battery of claim 1, wherein the cap plate includes a groove formed at a circumference of the sealing reinforcing member.

3. The rechargeable battery of claim 2, wherein a protrusion is formed on a circumference of the sealing reinforcing member in a form of a rib, and the protrusion protrudes toward the case.

4. The rechargeable battery of claim 1, wherein an elastic deformation protrusion is continuously formed on an interior circumference of the terminal hole along the interior circumference of the terminal hole.

5. The rechargeable battery of claim 4, wherein the elastic deformation protrusion is thinner than the peripheral region of the cap plate.

6. The rechargeable battery of claim 1, wherein a gasket is disposed at the terminal hole for insulating the electrode terminals from the cap plate, and
wherein a fixing groove is formed at a bottom side of the cap plate for receiving a protrusion formed at the gasket.

7. The rechargeable battery of claim 1, wherein the sealing reinforcing member protrudes toward a bottom side of the cap plate.

8. The rechargeable battery of claim 1, wherein the sealing reinforcing member protrudes toward a top side of the cap plate.

9. The rechargeable battery of claim 1, wherein a plurality of protrusions are formed on an interior circumference of the terminal hole.

10. The rechargeable battery of claim 1, wherein the rechargeable battery is a rectangular rechargeable battery.

11. The rechargeable battery of claim 1, wherein a bent supporting member is formed at an edge of the cap plate.

12. The rechargeable battery of claim 1, wherein the bent supporting member and a top portion of the case are in contact and are fixed by welding.

13. The rechargeable battery of claim 1, further comprising a gasket that includes a lower gasket inserted into the terminal hole and an upper gasket disposed at a top side of the cap plate.

14. A rechargeable battery comprising:
an electrode assembly having a separator, and an anode and a cathode disposed at both sides of the separator;
a case for housing the electrode assembly;
electrode terminals electrically connected to the electrode assembly and protruding outwardly from the case; and
a cap plate for closing and sealing the case, and having terminal holes defining interior circumferences for receiving the electrode terminals,
wherein an elastic deformation protrusion is formed on an interior circumference of each of the terminal holes.

15. The rechargeable battery of claim 14, wherein a sealing reinforcing member is formed on a circumference of the terminal hole, and the sealing reinforcing member is thicker than the cap plate,
wherein the elastic deformation protrusion is formed at an interior circumference of the sealing reinforcing member, and
wherein the elastic deformation protrusion is thinner than at a periphery thereof.

16. A rechargeable battery comprising:
an electrode assembly that includes an anode and a cathode arranged so as to produce a current therebetween;
a case for housing the electrode assembly;
electrode terminals respectively attached to the anode and the cathode so as to extend outward of the case;
a cap plate having a first thickness, wherein the cap plate includes at least two openings that receive the electrode terminals, wherein the area adjacent the at least two openings, the thickness of the cap plate is increased over the first thickness; and
a gasket interposed between the cap plate and the electrode terminals, wherein the increased thickness of the cap plate permits improved sealing between the cap plate and the electrodes.

17. The rechargeable battery of claim 16, wherein the cap plate includes an elastic deformation protrusion that is formed on an inner circumference of the at least two openings.

18. The rechargeable battery of claim 16, wherein the cap plate includes at least one fixing groove for inhibiting movement of the gasket with respect to the cap plate.

19. The rechargeable battery of claim 16, wherein the outer periphery of the cap plate is bent upwards and the bent upward region mates with the case to form a seal.

20. The rechargeable battery of claim 16, wherein the gaskets includes a lower gasket that is inserted into the opening of the cap plate and an upper gasket that is disposed on the top surface of the cap plate.
